(19) United States
(12) Patent Application Publication
(10) Pub. No.: US 2026/0273928 A1
(43) Pub. Date: Sep. 17, 2026

(54) PRINTING DEVICE AND CONTROL METHOD FOR PRINTING DEVICE

(71) Applicant: SEIKO EPSON CORPORATION, TOKYO (JP)

(72) Inventors: Akihiro MISHIMA, SHIOJIRI-SHI (JP); Jun KANNO, MATSUMOTO-SHI (JP); Manabu NEI, SHIOJIRI-SHI (JP); Yoshiki KIMURA, SHIOJIRI-SHI (JP)

(21) Appl. No.: 19/564,323

(22) Filed: Mar. 12, 2026

(30) Foreign Application Priority Data
Mar. 12, 2025 (JP) 2025-039109

(51) Int. Cl. B41J 2/045; B41J 2/165; B41J 11/00; B41J 15/16; B41J 25/00

(52) U.S. Cl. CPC B41J 2/04526; B41J 2/0451; B41J 2/04586; B41J 2/16508; B41J 11/002; B41J 11/0085; B41J 15/16; B41J 25/005

(57) ABSTRACT

According to an aspect of the present disclosure, a printing device executes print processing involving movement of a head by a carriage and ejection of ink onto a medium supported, and, in the case of, when the carriage is present in a printing operation area, detecting an abnormality based on output from a first state output unit configured to output, to a control unit, a state of an attraction, restricts the carriage from being moved to a standby position that is adjacent to the printing operation area and where the carriage stays on standby when the print processing is not executed, and, in the case of having detected an abnormality based on output from a second state output unit that outputs a state of a part different from the attraction unit to the control unit and having not detected an abnormality, moves the carriage to the standby position.

### CROSS-REFERENCE TO RELATED APPLICATION

The present application is based on, and claims priority from JP Application Serial Number 2025-039109, filed Mar. 12, 2025, the disclosure of which is hereby incorporated by reference herein in its entirety.

### BACKGROUND

### 1. Technical Field

The present disclosure relates to a printing device and a control method for a printing device.

### 2. Related Art

JP-A-2023-142651 discloses a printing device including a conveyance unit that conveys a medium in a conveyance direction, a support unit that supports the medium, and a head that performs printing by ejecting liquid onto the medium supported by the support unit. By moving in a direction extending along the conveyance direction, the head passes above the medium supported by the support unit from a position at the time of performing the printing on the medium and moves to a home position, which is a standby position. The medium supported by the support unit is attracted to the support unit by being sucked by an attraction unit through the support unit.

JP-A-2023-142651 is an example of the related art.

However, in the printing device disclosed in JP-A-2023-142651, when an abnormality such as suction failure occurs in the attraction unit, floating from the support unit is likely to occur in the medium. When the floating from the support unit has occurred in the medium, the head is likely to come into contact with the medium to be damaged when moving from the position at the time of performing the printing on the medium to the home position.

### SUMMARY

According to an aspect of the present disclosure, there is provided a printing device including: an attraction unit configured to attract a medium to a support unit; a head configured to eject liquid onto the medium; a carriage mounted with the head and configured to move in a main scanning direction with respect to the support unit; a control unit; a first state output unit configured to output a state of the attraction unit to the control unit; and a second state output unit configured to output a state of a part different from the attraction unit to the control unit, wherein the control unit controls the head and the carriage to execute print processing involving movement of the head by the carriage and the ejection of the liquid by the head onto the medium supported by the support unit, and, when an area where the carriage moves when the print processing is executed is represented as a printing operation area and a position that is adjacent to the printing operation area in the main scanning direction and where the carriage stays on standby when the print processing is not executed is represented as a standby position, in a case of having detected an abnormality based on output from the first state output unit when the carriage is present in the printing operation area, the control unit restricts the carriage from being moved to the standby position, and, in a case of having detected an abnormality based on output from the second state output unit and having not detected an abnormality based on output from the first state output unit when the carriage is present in the printing operation area, the control unit moves the carriage to the standby position.

According to an aspect of the present disclosure, there is provided a control method for a printing device including: an attraction unit configured to attract a medium to a support unit; a head configured to eject liquid onto the medium; a carriage mounted with the head and configured to move in a main scanning direction with respect to the support unit; a first state output unit configured to output a state of the attraction unit; and a second state output unit configured to output a state of a part different from the attraction unit, the printing device executing print processing involving movement of the head by the carriage and the ejection of the liquid by the head onto the medium supported by the support unit, the control method including: when an area where the carriage moves when the print processing is executed is represented as a printing operation area and a position that is adjacent to the printing operation area in the main scanning direction and where the carriage stays on standby when the print processing is not executed is represented as a standby position, in a case of having detected an abnormality based on output from the first state output unit when the carriage is present in the printing operation area, restricting the carriage from being moved to the standby position; and, in a case of having detected an abnormality based on output from the second state output unit and having not detected an abnormality based on output from the first state output unit when the carriage is present in the printing operation area, moving the carriage to the standby position.

### BRIEF DESCRIPTION OF THE DRAWINGS

FIG. 1 is a schematic configuration diagram in which a printing device according to an embodiment is viewed from a side.

FIG. 2 is a schematic configuration diagram in which the periphery of a support unit according to the embodiment is viewed from above.

FIG. 3 is a schematic configuration diagram in which the periphery of the support unit according to the embodiment is viewed from a side.

FIG. 4 is a flowchart illustrating a flow of processing in the case in which an abnormality has been detected at the time of a printing operation.

### DESCRIPTION OF EMBODIMENTS

Hereinafter, a printing device 11 according to the present disclosure is explained with reference to the drawings. The printing device 11 in an embodiment is, for example, an inkjet printer that prints characters and an image such as a photograph by ejecting ink, which is an example of liquid, onto paper, fabric, or the like, which is an example of a medium 99. The printing device 11 is, for example, a label printer.

In the figures, the same members are denoted by the same reference numerals and signs and redundant explanation of the members is sometimes omitted. The terms "same", "identical", and "simultaneous" described in the present specification do not indicate only being completely the same.

For example, the terms "same", "identical", and "simultaneous" described in the present specification include being the same when measurement errors are considered. The terms "same", "identical", and "simultaneous" described in the present specification include being the same when manufacturing variations of members are considered.

The terms "same", "identical", and "simultaneous" described in the present specification include being the same in a range in which functions are not spoiled. Thus, for example, "both dimensions are the same" indicates that the difference between both the dimensions is ±5% or less, particularly, preferably ±3% or less of one dimension when measurement errors and manufacturing variations of members are considered.

In the figures, X, Y, and Z represent three spatial axes orthogonal to one another. In the present specification, directions extending along these axes are represented as an X-axis direction, a Y-axis direction, and a Z-axis direction. When directions are specified, a positive direction is represented as "+" and a negative direction is represented as "-", the positive and negative signs are used together for direction notation, and a direction pointed by an arrow is described as a + direction and the direction opposite to the direction pointed by the arrow is described as a - direction in the figures.

The Z-axis direction indicates the direction of gravity, the +Z direction indicates a vertically upward direction, and the -Z direction indicates a vertically downward direction. A plane including the X axis and the Y axis is described as an X-Y plane, a plane including the X axis and the Z axis is described as an X-Z plane, and a plane including the Y axis and the Z axis is described as a Y-Z plane. The X-Y plane is the horizontal plane. The three spatial axes X, Y, and Z, which do not limit the positive direction and the negative direction, are described as an X axis, a Y axis, and a Z axis.

The X-axis direction is the horizontal direction extending along an installation surface, which is the horizontal plane, on which the printing device 11 is installed. The X-axis direction is the depth direction of the printing device 11 and is the width direction of the medium 99 conveyed in the printing device 11.

The Y-axis direction is the horizontal direction extending along the installation surface, which is the horizontal plane, on which the printing device 11 is installed. The Y-axis direction is the width direction of the printing device 11 and is a conveyance direction in which the medium 99 is conveyed on a support unit 17 of the printing device 11.

The Z-axis direction is the normal direction with respect to the installation surface on which the printing device 11 is installed and is the height direction of the printing device 11. In the following explanation, a direction in which the medium 99 moves by being conveyed is sometimes referred to as "downstream" and the direction opposite the direction is sometimes referred to as "upstream". For convenience of illustration, the sizes of members are sometimes different from actual sizes.

### Embodiment

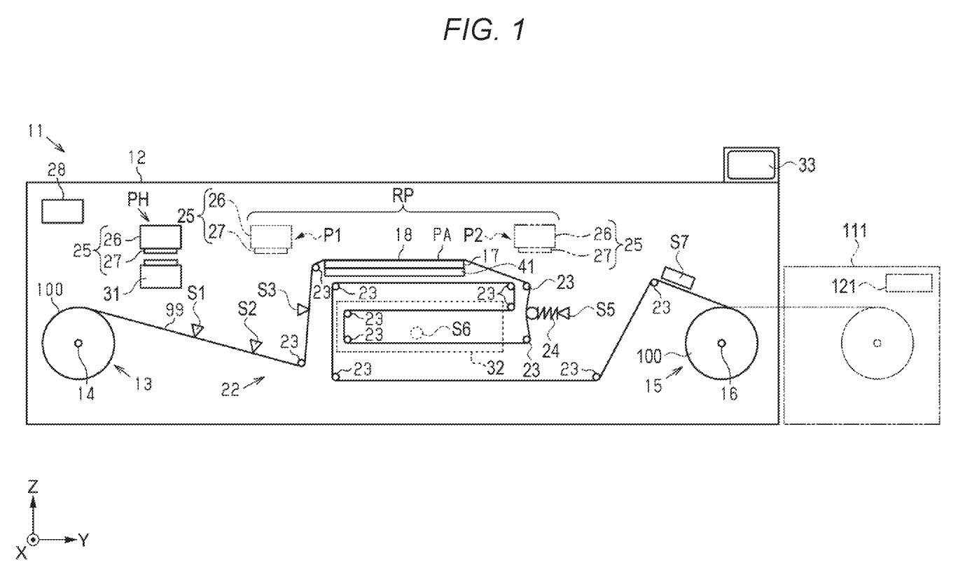

As illustrated in FIG. 1, the printing device 11 includes a housing 12. The printing device 11 includes a feeding unit 13 that feeds the medium 99. The feeding unit 13 is configured to feed the medium 99. The feeding unit 13 is housed in, for example, the housing 12.

The feeding unit 13 includes a feeding shaft 14. The feeding shaft 14 rotatably holds a roll body 100 obtained by winding and piling the medium 99. The feeding shaft 14 holds the medium 99 before printing. As the feeding shaft 14 rotates, the medium 99 is fed from the feeding unit 13. The feeding shaft 14 may be driven to rotate by a motor or may be driven to rotate as the medium 99 is pulled.

The printing device 11 includes a winding unit 15. The winding unit 15 is configured to wind the medium 99. The winding unit 15 is housed in, for example, the housing 12. The winding unit 15 includes a winding shaft 16. The winding shaft 16 rotatably holds the roll body 100 in the same manner as the feeding shaft 14 does. The winding shaft 16 holds the medium 99 after printing. As the winding shaft 16 rotates, the winding unit 15 winds the medium 99. The winding shaft 16 is driven to rotate by, for example, a motor.

The printing device 11 includes the support unit 17. The support unit 17 supports the medium 99. The support unit 17 is housed in, for example, the housing 12. The support unit 17 supports the medium 99, for example, from the downward side, which is the -Z direction side. The support unit 17 supports the medium 99 in a process from when the medium 99 is fed from the feeding unit 13 until when the medium 99 is wound by the winding unit 15.

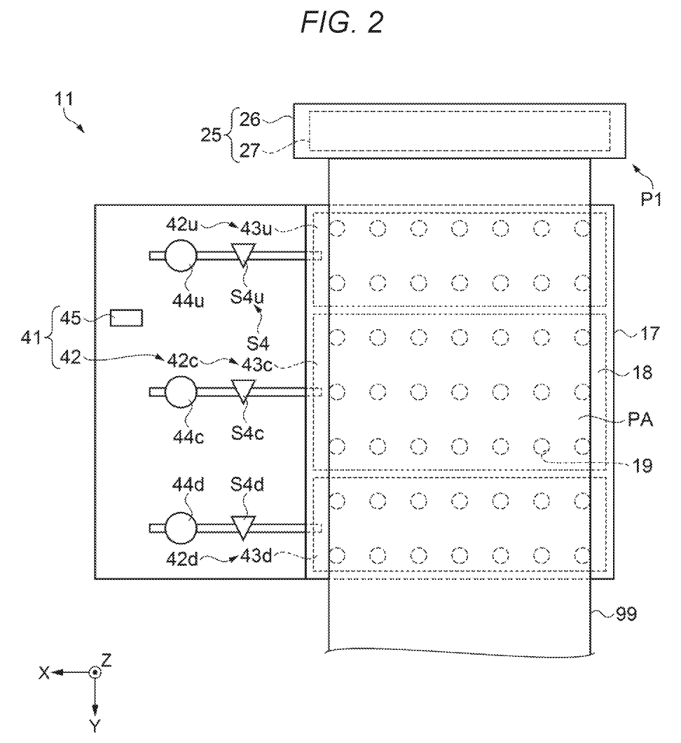

As illustrated in FIG. 2, the support unit 17 includes a support surface 18. The support surface 18 is a surface that comes into contact with the medium 99 in the support unit 17. The support surface 18 faces, for example, the upward direction, which is the +Z direction, in the support unit 17. When the support unit 17 is viewed from a position facing the support surface 18, that is, when the support unit 17 is viewed from above the support unit 17, the support surface 18 overlaps the medium 99.

An area supported by the support unit 17 in the medium 99 is a printing area PA. In the printing device 11, printing is applied to the printing area PA in the medium 99. The printing area PA is an area overlapping the support unit 17 in the medium 99 when the support unit 17 is viewed from a position facing the support surface 18. That is, the printing area PA overlaps the support surface 18 in a plan view of the support unit 17.

The printing area PA is, for example, an entire area supported by the support unit 17 in the medium 99. The printing area PA is not limited to the entire area supported by the support unit 17 in the medium 99 and may be a part of the area supported by the support unit 17. The printing area PA indicates, in the area supported by the support unit 17, a largest area where the printing device 11 is capable of carrying out printing.

The support unit 17 includes one or a plurality of through holes 19. The through holes 19 are opened in the support surface 18. The plurality of through holes 19 are provided in the support unit 17, for example, in a form in which a plurality of through holes 19 are disposed side by side at intervals in the X-axis direction to form a row of the through holes 19 and a plurality of rows of the through holes 19 are disposed side by side at intervals in the Y-axis direction. The through holes 19 are closed by, for example, the medium 99 located on the support surface 18.

The printing device 11 includes an attraction unit 41. The attraction unit 41 is configured to attract the medium 99 to the support unit 17. The attraction unit 41 attracts the medium 99 to the support unit 17 by, for example, causing negative pressure to act on the medium 99 through the support unit 17.

The attraction unit 41 includes a negative pressure generation mechanism 42 capable of generating negative pressure, a negative pressure control unit 45 that drives the negative pressure generation mechanism 42, and a pressure sensor S4 capable of detecting the negative pressure generated by the negative pressure generation mechanism 42. The negative pressure generation mechanism 42 includes negative pressure generation mechanisms 42u, 42c, and 42d disposed side by side in the Y-axis direction. The pressure sensor S4 includes pressure sensors S4u, S4c, and S4d.

The negative pressure generation mechanisms 42u, 42c, and 42d include negative pressure chambers 43u, 43c, and 43d and suction units 44u, 44c, and 44d. The negative pressure control unit 45 drives the suction units 44u, 44c, and 44d. The negative pressure chambers 43u, 43c, and 43d communicate with the through holes 19. The suction units 44u, 44c, and 44d disposed side by side in the Y-axis direction communicate with the negative pressure chambers 43u, 43c, and 43d disposed side by side in the Y-axis direction.

The suction units 44u, 44c, and 44d are capable of putting the negative pressure chambers 43u, 43c, and 43d under negative pressure by sucking air in the negative pressure chambers 43u, 43c, and 43d. The suction units 44u, 44c, and 44d are, for example, suction fans. The suction units 44u, 44c, and 44d may be suction pumps.

When the negative pressure control unit 45 drives the suction units 44u, 44c, and 44d, the attraction unit 41 can cause negative pressure to act on, via the negative pressure chambers 43u, 43c, and 43d and the through holes 19, the medium 99 supported by the support unit 17.

The negative pressure generation mechanism 42u includes the negative pressure chamber 43u, the suction unit 44u, and the pressure sensor S4u. The negative pressure chamber 43u communicates with the through holes 19 opened closer to the -Y direction side, which is the upstream side in a conveyance direction, than the center of the support surface 18. The suction unit 44u communicates with the negative pressure chamber 43u.

Accordingly, when the negative pressure control unit 45 drives the suction unit 44u, in the medium 99 supported by the support surface 18 of the support unit 17, a portion supported further on the upstream side, which is the -Y direction side, than the center of the support surface 18 is attracted to the support surface 18.

The negative pressure control unit 45 outputs, to a control unit 28 explained below, the driving status of the suction unit 44u, for example, a rotation amount of the suction fans, a current value or a voltage value of a motor that rotates the suction fans, and the like. The pressure sensor S4u detects the pressure in the negative pressure chamber 43u. The pressure sensor S4u outputs a value of the detected pressure in the negative pressure chamber 43u to the control unit 28.

The negative pressure generation mechanism 42c includes the negative pressure chamber 43c, the suction unit 44c, and the pressure sensor S4c. The negative pressure chamber 43c communicates with the through holes 19 opened in the center area in the conveyance direction of the support surface 18. The suction unit 44c communicates with the negative pressure chamber 43c.

Accordingly, when the negative pressure control unit 45 drives the suction unit 44c, in the medium 99 supported by the support surface 18 of the support unit 17, a portion supported in the center area in the conveyance direction of the support surface 18 is attracted to the support surface 18.

The negative pressure control unit 45 outputs the driving status of the suction unit 44c to the control unit 28. The pressure sensor S4c detects the pressure in the negative pressure chamber 43c. The pressure sensor S4c outputs a value of the detected pressure in the negative pressure chamber 43c to the control unit 28.

The negative pressure generation mechanism 42d includes the negative pressure chamber 43d, the suction unit 44d, and the pressure sensor S4d. The negative pressure chamber 43d communicates with the through holes 19 opened closer to the +Y direction side, which is the downstream side in the conveyance direction, than the center of the support surface 18. The suction unit 44d communicates with the negative pressure chamber 43d.

Accordingly, when the negative pressure control unit 45 drives the suction unit 44d, in the medium 99 supported by the support surface 18 of the support unit 17, a portion supported further on the downstream side, which is the +Y direction side, than the center of the support surface 18, is attracted to the support surface 18.

The negative pressure control unit 45 outputs the driving status of the suction unit 44d to the control unit 28. The pressure sensor S4d detects the pressure in the negative pressure chamber 43d. The pressure sensor S4d outputs a value of the detected pressure in the negative pressure chamber 43d to the control unit 28.

The negative pressure control unit 45 that outputs the driving statuses of the suction units 44u, 44c, and 44d to the control unit 28 is an example of a first state output unit that outputs a state of the attraction unit 41 to the control unit 28. The pressure sensors S4u, S4c, and S4d that output the pressure values in the negative pressure chambers 43u, 43c, and 43d to the control unit 28 are examples of the first state output unit that outputs the state of the attraction unit 41 to the control unit 28.

The attraction unit 41 is capable of changing an attraction force by adjusting the driving of the suction units 44u, 44c, and 44d by the negative pressure control unit 45, for example, based on the pressure values detected by the pressure sensors S4u, S4c, and S4d.

The attraction unit 41 changes the attraction force according to, for example, the conveyance of the medium 99. For example, when the medium 99 is conveyed, the attraction unit 41 reduces the attraction force compared with when the conveyance of the medium 99 is stopped.

When the medium 99 is conveyed, the attraction unit 41 relatively reduces the attraction force. Since the attraction force of the attraction unit 41 relatively decreases when the medium 99 is conveyed, the medium 99 easily moves on the support unit 17.

When printing is performed on the medium 99, that is, when the conveyance of the medium 99 is stopped, the attraction unit 41 relatively increases the attraction force. Since the attraction force of the attraction unit 41 relatively increases when the conveyance of the medium 99 is stopped, the position of the medium 99 less easily shifts on the support unit 17.

As illustrated in FIG. 1, the printing device 11 includes a conveyance unit 22. The conveyance unit 22 is configured to convey the medium 99. The conveyance unit 22 is housed in, for example, the housing 12. The conveyance unit 22 conveys the medium 99 in the conveyance direction extending along a conveyance path extending from the feeding unit 13 toward the winding unit 15 downstream in the conveyance direction. The conveyance direction of the medium 99 indicates a direction in which the medium 99 moves along the conveyance path.

The conveyance unit 22 conveys, on the support unit 17, the medium 99 in the conveyance direction extending along the Y-axis direction. The conveyance unit 22 conveys, further downward than the support unit 17, a portion having passed over the support unit 17 in the medium 99. That is, the printed medium 99 is conveyed from the support unit 17 further downward than the support unit 17 by the conveyance unit 22.

The conveyance unit 22 intermittently conveys the medium 99. That is, the conveyance unit 22 repeats the start and the stop of conveyance. The conveyance unit 22 stops the conveyance of the medium 99 when printing on the medium 99 is executed. When printing on the medium 99 is not executed, for example, when printing on the medium 99 is completed, the conveyance unit 22 starts the conveyance of the medium 99.

In the printing device 11, the printing on the medium 99 and the conveyance of the medium 99 are alternately repeated. Here, "when the printing on the medium 99 is completed" means when printing on an area where a printing unit 25 explained below is scheduled to perform printing is completed in a period in which the medium 99 is stopped between conveyance and conveyance in the intermittent conveyance.

The conveyance unit 22 includes one or more conveyance rollers 23. The conveyance rollers 23 are located in, for example, the housing 12. The conveyance rollers 23 rotate to thereby convey the medium 99. The medium 99 is wound on the conveyance rollers 23.

The conveyance rollers 23 may sandwich the medium 99. The conveyance rollers 23 rotate, whereby the medium 99 is conveyed. The conveyance rollers 23 include, for example, a roller driven to rotate by a motor. The conveyance rollers 23 are located, for example, below the support surface 18.

The printing device 11 includes a meandering sensor S1, a tape sensor S2, and a foreign matter sensor S3 at positions between the feeding unit 13 and the support unit 17 in the conveyance direction in the conveyance path.

The meandering sensor S1 detects a degree of meandering of the medium 99 conveyed by the conveyance unit 22. The meandering sensor S1 outputs the detected degree of the meandering of the medium 99 to the control unit 28. The meandering sensor S1 that outputs the degree of the meandering of the medium 99 conveyed by the conveyance unit 22 to the control unit 28 is an example of a second state output unit that outputs a state of a part different from the attraction unit 41 to the control unit 28.

When the roll body 100 is configured by connecting a plurality of media 99 with a tape, the tape sensor S2 detects the tape connecting the plurality of media 99. The tape sensor S2 outputs the presence or absence of the tape to the control unit 28.

The tape sensor S2 that outputs the presence or absence of the tape connecting the plurality of media 99 to the control unit 28 is an example of the second state output unit that outputs the state of the part different from the attraction unit 41 to the control unit 28.

The foreign matter sensor S3 detects foreign matters adhering to the medium 99. The foreign matter sensor S3 outputs the presence or absence of foreign matters to the control unit 28. The foreign matter sensor S3 that outputs the presence or absence of foreign matters adhering to the medium 99 to the control unit 28 is an example of the second state output unit that outputs the state of the part different from the attraction unit 41 to the control unit 28.

The printing device 11 includes a tension applying mechanism 24 at a position between the support unit 17 and the winding unit 15 in the conveyance direction in the conveyance path. The tension applying mechanism 24 applies tension to the medium 99 by, for example, pressing the medium 99 with a rod-shaped member cylindrical in cross section extending in the X-axis direction.

The printing device 11 includes a tension detection unit S5 that detects the tension applied to the medium 99 by the tension applying mechanism 24. The tension detection unit S5 outputs a value of the detected tension to the control unit 28.

The tension detection unit S5 that outputs the value of the tension applied to the medium 99 by the tension applying mechanism 24 to the control unit 28 is an example of the second state output unit that outputs the state of the part different from the attraction unit 41 to the control unit 28.

The tension applying mechanism 24 may be provided at a position closer to the winding unit 15 in the conveyance direction. In this case, by, for example, pressing the medium 99 with the weight of a rod-shaped member cylindrical in cross section extending in the X-axis direction, the tension applying mechanism 24 may apply tension to the medium 99 wound by the winding unit 15.

The printing device 11 includes a drying unit 32 at a position between the support unit 17 and the winding unit 15 in the conveyance path. The drying unit 32 is configured to dry the medium 99 on which print processing has been executed. The drying unit 32 dries the medium 99 in a process in which the medium 99 is conveyed from the support unit 17 to the winding unit 15.

The drying unit 32 is located in, for example, the housing 12. The drying unit 32 is located, for example, directly below the support unit 17. The drying unit 32 includes, for example, a heater that heats the medium 99 passing through a drying area indicated by a broken line in FIG. 1. The drying unit 32 may include a fan that blows gas onto the medium 99. Accordingly, the drying unit 32 dries the medium 99.

The printing device 11 includes a temperature control unit S6 for controlling the temperature of the drying area of the drying unit 32. The temperature control unit S6 may be a temperature sensor that detects the temperature of the drying area. In this case, the temperature control unit S6 outputs the detected temperature of the drying area to the control unit 28.

Alternatively, the temperature control unit S6 may be a thermostat that detects the temperature of the drying area and adjusts the temperature of the drying area. In this case, the temperature control unit S6 outputs the temperature of the drying area and the operation status of the temperature control unit S6 to the control unit 28.

The temperature control unit S6 that outputs the temperature of the drying area of the drying unit 32 or the operation status of the temperature control unit S6 to the control unit 28 is an example of the second state output unit that outputs the state of the part different from the attraction unit 41 to the control unit 28.

The printing device 11 includes a reading sensor S7 at a position between the support unit 17 and the winding unit 15 in the conveyance path. The reading sensor S7 is configured to read the medium 99 on which the print processing has been executed.

The reading sensor S7 in the present embodiment is provided on the conveyance path to be capable of reading the printing surface of the medium 99 dried by the drying unit 32 after the print processing has been executed. The reading sensor S7 outputs a result of reading an image or the like printed on the medium 99 to the control unit 28.

The reading sensor S7 that outputs the result of reading the image or the like printed on the medium 99 to the control unit 28 is an example of the second state output unit that outputs the state of the part different from the attraction unit 41 to the control unit 28.

The printing device 11 includes a printing unit 25. The printing unit 25 is configured to perform printing on the medium 99. The printing unit 25 performs printing on the medium 99 by ejecting ink onto the medium 99. The printing unit 25 performs printing in the printing area PA.

The printing unit 25 is housed in, for example, the housing 12. The printing unit 25 includes a carriage 26 and a head 27. The carriage 26 and the head 27 are located, for example, above the support unit 17.

The head 27 is mounted on the carriage 26. The carriage 26 is configured to move with respect to the medium 99. The carriage 26 moves with respect to the printing area PA. The carriage 26 moves in an area facing the support surface 18 of the support unit 17. In a plan view of the support unit 17, the carriage 26 moves to pass through the printing area PA. The carriage 26 moves, for example, in an area above the support surface 18 of the support unit 17.

The carriage 26 is mounted with the head 27 and configured to move, with respect to the support unit 17, in the main scanning direction extending along the Y-axis direction. The Y-axis direction is an example of the main scanning direction in which the carriage 26 moves. Specifically, the carriage 26 reciprocates in the Y-axis direction. That is, the carriage 26 moves in a direction extending along the conveyance direction of the medium 99 supported by the support unit 17.

The carriage 26 may be configured to move in a sub scanning direction extending along the X-axis direction. The X-axis direction is an example of the sub scanning direction in which the carriage 26 moves. The sub scanning direction is a direction different from the conveyance direction. Specifically, the sub scanning direction is a direction intersecting the conveyance direction in the X-Y plane that is along the support surface 18. The sub scanning direction can also be referred to as direction extending along the width direction of the conveyed medium 99.

The carriage 26 may be configured to move only in the Y-axis direction or may be configured to move in both of the Y-axis direction and the X-axis direction. In this case, the printing device 11 is a so-called lateral printer. As another embodiment different from the present embodiment, the carriage 26 may be configured to move only in the X-axis direction. In this case, the printing device 11 is a so-called serial printer.

In the present embodiment, the carriage 26 moves at least in the Y-axis direction. For that reason, in the present embodiment, the X-axis direction indicates a line feed direction with respect to a direction in which the carriage 26 moves with respect to the medium 99. That is, the X-axis direction indicates a direction in which the carriage 26 or the head 27 starts a new line with respect to a direction in which the head 27 moves while ejecting the ink onto the medium 99.

The carriage 26 or the head 27 may move on a forward path and a backward path in the X-axis direction. That is, the carriage 26 or the head 27 may move to, for example, one side and the other side opposite the one side in the X-axis direction.

The carriage 26 is displaced to a plurality of positions by moving. The carriage 26 is displaced to a first position P1, a second position P2, and a standby position PH by, for example, moving in the Y-axis direction.

A first position P1 and a second position P2 indicated by alternate long and two short dashes lines in FIG. 1 are positions through which the carriage 26 passes at the time of the print processing. The first position P1 is a position on the -Y direction side with respect to the support unit 17.

The first position P1 is a position further upstream than the support unit 17 in the conveyance direction. The second position P2 is a position on the +Y direction side with respect to the support unit 17. The second position P2 is a position further downstream than the support unit 17 in the conveyance direction.

For example, when the print processing is performed, the carriage 26 reciprocates between the first position P1 and the second position P2. Hereinafter, an area where the carriage 26 moves when the print processing is performed, that is, an area between the first position P1 and the second position P2 in the Y-axis direction is sometimes referred to as printing operation area RP. The carriage 26 passes above the support unit 17 in a process of being displaced from the first position P1 to the second position P2 and in a process of being displaced from the second position P2 to the first position P1.

One of the first position P1 and the second position P2 is a start position that is a start position of printing. The other of the first position P1 and the second position P2 is a return position that is a turnaround position of the printing.

The carriage 26 stays on standby at the start position before the printing is started. When the printing is started, the carriage 26 moves from the start position to the return position. When reaching the return position, the carriage 26 turns around from the return position to the start position.

In the carriage 26, the movement from the start position side to the return position side is sometimes referred to as forward path movement and the movement from the return position side to the start position side is sometimes referred to as backward path movement.

The standby position PH is a position where the carriage 26 stays on standby. The carriage 26 normally stays on standby at the standby position PH. The carriage 26 is located at the standby position PH, for example, when the printing unit 25 does not perform printing on the medium 99.

The standby position PH is, for example, a position further upstream than the support unit 17 in the conveyance direction. The standby position PH is a position further upstream than the first position P1 in the conveyance direction. The standby position PH is adjacent to the printing operation area RP at an interval in the Y-axis direction and is located in the -Y direction of the printing operation area RP.

The carriage 26 moves from the standby position PH to the start position before the printing is started. In the present embodiment, for example, the start position is the first position P1 close to the standby position PH.

The head 27 includes one or more nozzles. The nozzles are opened in a nozzle surface that is a surface facing the -Z direction of the head 27. The head 27 ejects the ink from the nozzles. The head 27 ejects the ink onto the medium 99 supported by the support unit 17.

Specifically, the head 27 ejects the ink to the printing area PA. The head 27 ejects the ink onto the medium 99 while the conveyance of the medium 99 by the conveyance unit 22 is stopped. Accordingly, an image is printed on the medium 99.

The head 27 moves with respect to the support unit 17 together with the carriage 26. The head 27 ejects the ink onto the medium 99 while moving together with the carriage 26. Specifically, the head 27 ejects the ink onto the medium 99 while moving in one direction together with the carriage 26.

The head 27 ejects the ink onto the medium 99, for example, while moving in the Y-axis direction together with the carriage 26. When the printing device 11 is a serial printer, the head 27 ejects the ink onto the medium 99 while moving in the X-axis direction together with the carriage 26.

In the present embodiment, the width of the head 27 is, for example, the same as the width of the medium 99 or larger than the width of the medium 99. That is, the head 27 is, for example, a line head capable of simultaneously ejecting the ink over the entire width of the medium 99.

Accordingly, the head 27 can eject the ink to the entire printing area PA only by moving once in the Y-axis direction together with the carriage 26. That is, the head 27 can perform printing in the entire printing area PA without the carriage 26 moving in the X-axis direction.

The width of the head 27 may be smaller than the width of the medium 99. In this case, the head 27 ejects the ink over the entire width of the medium 99 by moving in both of the Y-axis direction and the X-axis direction.

For example, the head 27 performs printing over the entire width of the medium 99 by, for example, repeating the movement involving the ink ejection and the line feed, that is, alternately repeating the movement in the Y-axis direction and the movement in the X-axis direction. Therefore, in this case, the head 27 performs printing in the entire printing area PA by the carriage 26 reciprocating in the Y-axis direction and performing the line feed in the X-axis direction.

The printing unit 25 performs printing with a predetermined number of passes. The number of passes indicates the number of times the head 27 moves in order to complete printing in a predetermined area. The number of passes is, for example, the number of times of movement of the carriage 26 with respect to the printing area PA involving ejection of the ink by the head 27.

For example, the printing unit 25 performs printing in the printing area PA with one pass. In this case, the printing by the head 27 is completed by the carriage 26 passing through the printing area PA once. The printing unit 25 may perform printing in the printing area PA with multiple passes. In this case, the printing by the head 27 is completed by the carriage 26 passing through the printing area PA a plurality of times.

The printing unit 25 carries out, for example, unidirectional printing on the medium 99. The unidirectional printing is a printing scheme in which there is one direction of movement of the carriage 26 involving ejection of the ink onto the medium 99. In the unidirectional printing, the printing unit 25 ejects the ink onto the medium 99, for example, as the printing unit 25 moves in the +Y direction or the -Y direction.

That is, the unidirectional printing is a printing scheme involving, when the carriage 26 reciprocates with respect to the medium 99, ejection of the ink by the head 27 in a forward path or a backward path of the reciprocation.

The printing unit 25 may carry out bidirectional printing on the medium 99. The bidirectional printing is a printing scheme in which there are a plurality of directions of movement of the carriage 26 involving ejection of the ink onto the medium 99. In the bidirectional printing, the printing unit 25 ejects the ink, for example, as the printing unit 25 moves in the +Y direction and the -Y direction.

That is, the bidirectional printing is a printing scheme in which, when the carriage 26 reciprocates with respect to the medium 99, the ink is ejected by the head 27 in both a forward path and a backward path of the reciprocation.

The printing device 11 includes a cap 31. The cap 31 is provided in the housing 12 to be capable of covering the nozzle surface of the head 27 when the carriage 26 is located at the standby position PH. The cap 31 moves between a capping position and a separated position when a not-illustrated cap mechanism is driven.

The capping position is a position where the cap 31 comes into contact with the nozzle surface of the head 27 and is a position where the cap 31 covers the nozzle surface. Since the nozzle surface of the head 27 is covered by the cap 31, the ink is prevented from being thickened because a solvent component of the ink volatilizes via the nozzles of the head 27.

Accordingly, ink ejection failure from the nozzles is reduced. As illustrated in FIG. 1, the separated position is a position where the cap 31 is separated from the head 27. The separated position is provided on the -Z direction side of the capping position.

The printing device 11 includes a maintenance mechanism (not illustrated) that maintains the head 27 when the carriage 26 is located at the standby position PH. The maintenance mechanism may include, for example, a wiper that wipes the nozzle surface of the head 27.

The maintenance mechanism may include, for example, a suction pump that applies negative pressure to the nozzles of the head 27 via the cap 31 when the head 27 is capped by the cap 31.

Since the negative pressure is applied to the nozzles, the ink thickened in the head 27 and foreign matters in the ink are discharged to the cap 31 via the nozzles. Accordingly, ink ejection failure from the nozzles is reduced.

The printing device 11 includes a notification unit 33. The notification unit 33 includes a display unit (not illustrated) including a touch panel. The notification unit 33 notifies, for example, a state of the printing device 11 to a user by, for example, displaying a message or the like on the display unit. The user can input an instruction to the printing device 11 by touching the display unit. The notification unit 33 may include an operation button.

The printing device 11 includes the control unit 28. The control unit 28 comprehensively controls the printing device 11. The control unit 28 controls, for example, the conveyance unit 22, the printing unit 25, the attraction unit 41, the drying unit 32, and the notification unit 33.

The control unit 28 includes one or more processors that execute various kinds of processing according to computer programs. The control unit 28 includes one or more dedicated hardware circuits such as application specific integrated circuits that execute at least some of the various kinds of processing. The control unit 28 may include a circuit including a combination of a processor and a hardware circuit.

The processor includes a CPU and memories such as a RAM and a ROM. The memories store program codes or commands configured to cause the CPU to execute processing. The memories, that is, computer-readable media include all readable media that can be accessed by a general-purpose or dedicated computer.

For example, the control unit 28 controls the conveyance unit 22 and the printing unit 25 to alternately execute conveyance of the medium 99 and printing on the medium 99. In the printing on the medium 99, the control unit 28 controls the head 27 and the carriage 26 of the printing unit 25.

Accordingly, the control unit 28 executes print processing involving movement of the head 27 in the main scanning direction by the carriage 26 and ejection of the ink by the head 27 onto the medium 99 supported by the support unit 17.

For example, the control unit 28 detects an abnormality of any part of the printing device 11 based on output from the first state output unit or the second state output unit. The control unit 28 performs operation processing for the units of the printing device 11 based on the detected abnormality. The control unit 28 controls the notification unit 33 to display a message or the like on the display unit to notify the user that the abnormality has occurred in the printing device 11.

When a post-processing device 111 is coupled to the printing device 11 as indicated by an alternate long and two short dashes line in FIG. 1, the control unit 28 may control an operation of the post-processing device 111 that applies post-processing to the printed medium 99. The control of the operation of the post-processing device 111 by the control unit 28 is performed via an I/O unit 121 provided in the post-processing device 111.

The I/O unit 121 outputs the operation status of the post-processing device 111 to the control unit 28. In this case, the I/O unit 121 that outputs the operation status of the post-processing device 111 to the control unit 28 is an example of the second state output unit that outputs the state of the part different from the attraction unit 41 to the control unit 28.

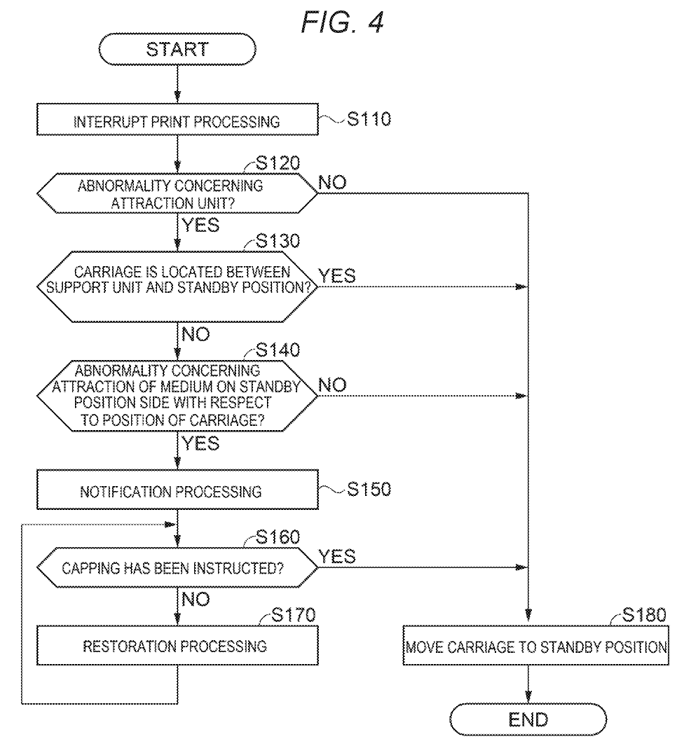

Next, a flow of processing performed by the control unit 28 when an abnormality has been detected during the print processing on the medium 99 is explained with reference to a flowchart illustrated in FIG. 4. The flow of the processing performed by the control unit 28 when an abnormality has been detected during the print processing on the medium 99 corresponds to a control method for the printing device 11.

In the case of having detected an abnormality of any part of the printing device 11 when the print processing on the medium 99 is executed, first, the control unit 28 executes interruption of the print processing in step S110.

Specifically, the control unit 28 controls the carriage 26 and the head 27 of the printing unit 25 to interrupt the movement of the carriage 26 in the Y-axis direction and the ejection of the ink from the nozzles of the head 27 onto the medium 99.

When the processing in step S110 ends, the control unit 28 shifts the processing to step S120.

In step S120, the control unit 28 checks whether the detected abnormality is an abnormality concerning the attraction unit 41. Specifically, the control unit 28 checks whether the detected abnormality is an abnormality based on output from the first state output unit or the second state output unit.

When the detected abnormality is an abnormality based on output from the first state output unit, the control unit 28 determines that the detected abnormality is an abnormality concerning the attraction unit 41. Thus, the control unit 28 determines YES in step S120 and shifts the processing to step S130.

When the control unit 28 determines YES in step S120, it is likely that floating in the +Z direction from the support surface 18 has occurred in the medium 99. When the floating of the medium 99 from the support surface 18 has occurred, the head 27 is likely to come into contact with the medium 99 by being moved. The head 27 is likely to be damaged by coming into contact with the medium 99.

For this reason, when determining in step S120 that the detected abnormality is an abnormality concerning the attraction unit 41, the control unit 28 causes the carriage 26 to stay in place. That is, in the case of having detected an abnormality based on output from the first state output unit when the carriage 26 is present in the printing operation area RP, the control unit 28 restricts the carriage 26 from being moved to the standby position PH.

When the detected abnormality is an abnormality based on output from the second state output unit, the control unit 28 determines that the detected abnormality is an abnormality concerning a part different from the attraction unit 41. At this time, the control unit 28 has not detected an abnormality based on output from the first state output unit. Thus, the control unit 28 determines NO in step S120 and shifts the processing to step S180.

In step S180, the control unit 28 moves the carriage 26 to the standby position PH. Specifically, the control unit 28 controls the carriage 26 to move to the standby position PH.

After performing maintenance of the head 27 according to necessity, the control unit 28 controls the cap mechanism to move the cap 31 from the separated position to the capping position. Accordingly, the nozzle surface of the head 27 is capped.

After ending the processing in step S180, the control unit 28 ends the processing performed when an abnormality has been detected during the print processing.

In step S130, the control unit 28 checks whether the carriage 26 is located between the support unit 17 and the standby position PH. For example, when the carriage 26 is located at the first position P1, the carriage 26 is located between the support unit 17 and the standby position PH in the Y-axis direction.

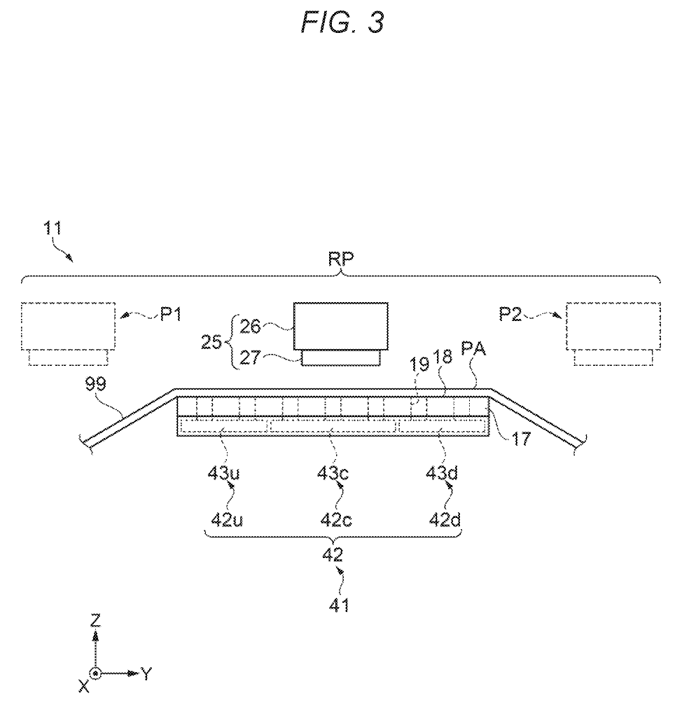

For example, when the carriage 26 is located at the second position P2, the carriage 26 is not located between the support unit 17 and the standby position PH in the Y-axis direction. For example, as indicated by a solid line in FIG. 3, when the carriage 26 is located vertically above the center in the Y-axis direction of the support unit 17, the carriage 26 is not located between the support unit 17 and the standby position PH in the Y-axis direction.

When the carriage 26 is located between the support unit 17 and the standby position PH in the Y-axis direction, the control unit 28 determines YES in step S130, shifts the processing to step S180, and moves the carriage 26 to the standby position PH. After ending the processing in step S180, the control unit 28 ends the processing performed when an abnormality has been detected during the print processing.

When the carriage 26 is not located between the support unit 17 and the standby position PH in the Y-axis direction, the control unit 28 determines NO in step S130 and shifts the processing to step S140.

When the control unit 28 determines NO in step S130, the head 27 is likely to come into contact with the medium 99 by moving the carriage 26 toward the standby position PH. The head 27 is likely to be damaged by coming into contact with the medium 99.

Therefore, when the carriage 26 is not located between the support unit 17 and the standby position PH in the Y-axis direction in step S130, the control unit 28 causes the carriage 26 to stay in place. That is, when the carriage 26 is not located between the support unit 17 and the standby position PH in the Y-axis direction, the control unit 28 restricts the carriage 26 from being moved to the standby position PH.

In step S140, the control unit 28 checks whether the detected abnormality is an abnormality concerning attraction of the medium 99 on the standby position PH side with respect to the position of the carriage 26. By checking output from which sensor of the first state output unit the detected abnormality is based on, the control unit 28 specifies a place where the abnormality concerning the attraction of the medium 99 has occurred.

For example, when the detected abnormality is an abnormality based on output from the pressure sensor S4u, it can be presumed that an abnormality has occurred in the negative pressure generation mechanism 42u of the attraction unit 41. When the detected abnormality is an abnormality based on output from the pressure sensor S4c, it can be presumed that an abnormality has occurred in the negative pressure generation mechanism 42c of the attraction unit 41. When the detected abnormality is an abnormality based on output from the pressure sensor S4d, it can be presumed that an abnormality has occurred in the negative pressure generation mechanism 42d of the attraction unit 41.

Alternatively, by checking the driving statuses of the suction units 44u, 44c, and 44d output from the negative pressure control unit 45 provided in the first state output unit, the control unit 28 may specify a place where the abnormality concerning the attraction of the medium 99 has occurred.

For example, when the detected abnormality is an abnormality based on the driving status of the suction unit 44u output from the negative pressure control unit 45, it can be presumed that an abnormality has occurred in the negative pressure generation mechanism 42u of the attraction unit 41.

When the detected abnormality is an abnormality based on the driving status of the suction unit 44c output from the negative pressure control unit 45, it can be presumed that an abnormality has occurred in the negative pressure generation mechanism 42c of the attraction unit 41. When the detected abnormality is an abnormality based on the driving status of the suction unit 44d output from the negative pressure control unit 45, it can be presumed that an abnormality has occurred in the negative pressure generation mechanism 42d of the attraction unit 41.

For example, it is assumed that an abnormality has occurred in any one of the negative pressure generation mechanisms 42u, 42c, and 42d and the carriage 26 is located at the second position P2. In this case, the through holes 19 communicating with any one of the negative pressure chambers 43u, 43c, and 43d of the negative pressure generation mechanism 42 are located on the -Y direction side with respect to the carriage 26. Thus, in this case, the control unit 28 determines that the detected abnormality is an abnormality concerning attraction of the medium 99 on the standby position PH side with respect to the position of the carriage 26 in the Y-axis direction.

For example, it is assumed that an abnormality has occurred in the negative pressure generation mechanism 42u and the carriage 26 is present at a position indicated by a solid line in FIG. 3. In this case, the through holes 19 communicating with the negative pressure chamber 43u of the negative pressure generation mechanism 42u are located on the -Y direction side with respect to the carriage 26. Thus, in this case, the control unit 28 determines that the detected abnormality is an abnormality concerning attraction of the medium 99 on the standby position PH side with respect to the position of the carriage 26 in the Y-axis direction.

For example, it is assumed that an abnormality has occurred in the negative pressure generation mechanism 42c and the carriage 26 is present at the position indicated by the solid line in FIG. 3. In this case, the through holes 19 communicating with the negative pressure chamber 43c of the negative pressure generation mechanism 42c include the through holes 19 located on the -Y direction side with respect to the carriage 26. Thus, in this case, the control unit 28 determines that the detected abnormality is an abnormality concerning attraction of the medium 99 on the standby position PH side with respect to the position of the carriage 26 in the Y-axis direction.

For example, it is assumed that an abnormality has occurred in the negative pressure generation mechanism 42d of the attraction unit 41 and the carriage 26 is present at the position indicated by the solid line in FIG. 3. In this case, the through holes 19 communicating with the negative pressure chamber 43d of the negative pressure generation mechanism 42d are located on the +Y direction side with respect to the carriage 26. Thus, in this case, the control unit 28 determines that the detected abnormality is not an abnormality concerning attraction of the medium 99 on the standby position PH side with respect to the position of the carriage 26 in the Y-axis direction.

When the detected abnormality is an abnormality concerning attraction of the medium 99 on the standby position PH side with respect to the position of the carriage 26, the control unit 28 determines YES in step S140 and shifts the processing to step S150.

When the control unit 28 determines YES in step S140, the head 27 is likely to come into contact with the medium 99 by moving the carriage 26 toward the standby position PH. The head 27 is likely to be damaged by coming into contact with the medium 99.

For this reason, in step S140, when the detected abnormality is an abnormality concerning attraction of the medium 99 on the standby position PH side with respect to the position of the carriage 26, the control unit 28 causes the carriage 26 to stay in place. That is, when the detected abnormality is an abnormality concerning attraction of the medium 99 on the standby position PH side with respect to the position of the carriage 26, the control unit 28 restricts the carriage 26 from being moved to the standby position PH.

When the detected abnormality is an abnormality concerning attraction of the medium 99 on the side opposite to the standby position PH with respect to the position of the carriage 26 in the Y-axis direction, the detected abnormality is not an abnormality concerning attraction of the medium 99 on the standby position PH side with respect to the position of the carriage 26.

In this case, the control unit 28 determines NO in step S140, shifts the processing to step S180, and moves the carriage 26 to the standby position PH. After ending the processing in step S180, the control unit 28 ends the processing performed when an abnormality has been detected during the print processing.

In step S150, the control unit 28 executes notification processing. Specifically, the control unit 28 controls the notification unit 33 to notify that an abnormality concerning the attraction unit 41 has occurred in the printing device 11 and requests the user to check the attraction unit 41. At this time, for example, the control unit 28 displays, on the display unit of the notification unit 33, an input button for receiving an instruction to cap the head 27.

When the processing in step S150 ends, the control unit 28 shifts the processing to step S160.

In step S160, the control unit 28 checks whether capping has been instructed. Specifically, the control unit 28 checks whether a capping instruction has been input from the display unit of the notification unit 33.

When the capping instruction has not been input, the control unit 28 determines NO in step S160 and shifts the processing to step S170.

In step S170, the control unit 28 executes restoration processing. Specifically, the control unit 28 performs, according to an instruction from the user, operation control for the attraction unit 41 or other parts necessary for checking or maintenance of the attraction unit 41.

When the processing in step S170 ends, the control unit 28 shifts the processing to step S160 again and continues to check whether capping has been instructed.

When the capping instruction has been input in step S160, the control unit 28 determines YES in step S160, shifts the processing to step S180, and moves the carriage 26 to the standby position PH.

After ending the processing in step S180, the control unit 28 ends the processing performed when an abnormality has been detected during the print processing.

In this processing, when an abnormality concerning a part different from the attraction unit 41 has been detected, the control unit 28 controls the notification unit 33 to notify that the abnormality has occurred in the part and urges the user to check the part.

As explained above, with the printing device 11 and the control method for the printing device 11 according to the present embodiment, the following effects can be obtained.

The printing device 11 includes the attraction unit 41 that attracts the medium 99 to the support unit 17. The printing device 11 includes the head 27 that ejects the ink onto the medium 99 and the carriage 26 that is mounted with the head 27 and moves in the Y-axis direction with respect to the support unit 17. The printing device 11 includes the control unit 28. The printing device 11 includes the first state output unit that outputs a state of the attraction unit 41 to the control unit 28 and the second state output unit that outputs a state of a part different from the attraction unit 41 to the control unit 28. The control unit 28 controls the head 27 and the carriage 26 to execute the print processing involving the movement of the head 27 by the carriage 26 and the ejection of the ink by the head 27 onto the medium 99 supported by the support unit 17. The area where the carriage 26 moves when the print processing is executed is represented as the printing operation area RP and the position that is adjacent to the printing operation area RP in the Y-axis direction and where the carriage 26 stays on standby when the print processing is not executed is represented as the standby position PH. At this time, in the case of having detected an abnormality based on output from the first state output unit when the carriage 26 is present in the printing operation area RP, the control unit 28 restricts the carriage 26 from being moved to the standby position PH. In the case of having detected an abnormality based on output from the second state output unit and having not detected an abnormality based on output from the first state output unit when the carriage 26 is present in the printing operation area RP, the control unit 28 moves the carriage 26 to the standby position PH.

Accordingly, when the carriage 26 is moved from the printing operation area RP to the standby position PH, it is possible to prevent the head 27 from coming into contact with the medium 99 floating from the support unit 17 because of an abnormality of the attraction unit 41. Since the carriage 26 is moved to the standby position PH when an abnormality concerning the attraction unit 41 has not been detected, it is possible to prevent the nozzles of the head 27 from drying.

The head 27 has the nozzle surface in which the nozzles for ejecting the ink are provided. The printing device 11 further includes the cap 31 capable of covering the nozzle surface when the carriage 26 is present at the standby position PH.

Accordingly, when the carriage 26 is present at the standby position PH, the nozzle surface of the head 27 can be covered. Accordingly, since the nozzles can be prevented from drying, it is possible to reduce deterioration in image quality in printing and an increase in a maintenance time of the head 27 due to ink ejection failure or the like.

The attraction unit 41 includes the negative pressure generation mechanism 42 that generates negative pressure and the pressure sensor S4 that detects the negative pressure generated by the negative pressure generation mechanism 42. The pressure sensor S4 functions as the first state output unit. Accordingly, it is possible to easily detect, based on output from the pressure sensor S4, occurrence of an abnormality concerning the attraction unit 41.

The attraction unit 41 includes the negative pressure generation mechanism 42 that generates negative pressure and the negative pressure control unit 45 that drives the negative pressure generation mechanism 42. The negative pressure control unit 45 functions as the first state output unit. Accordingly, it is possible to easily detect, based on output from the negative pressure control unit 45, occurrence of an abnormality concerning the attraction unit 41.

The printing device 11 includes the tension applying mechanism 24 that applies tension to the medium 99 and the tension detection unit S5 that detects the tension applied to the medium 99 by the tension applying mechanism 24. The tension detection unit S5 functions as the second state output unit. Accordingly, it is possible to easily detect, based on output from the tension detection unit S5, occurrence of an abnormality concerning the tension applying mechanism 24, which is the part different from the attraction unit 41.

The printing device 11 includes the drying unit 32 that dries the medium 99 on which the print processing has been executed and the temperature control unit S6 capable of detecting the temperature of the drying unit 32. The temperature control unit S6 functions as the second state output unit. Accordingly, it is possible to easily detect, based on output from the temperature control unit S6, occurrence of an abnormality concerning the drying unit 32, which is the part different from the attraction unit 41.

It is assumed that, when the carriage 26 is present in the printing operation area RP, an abnormality is detected based on output from the first state output unit and the carriage 26 is located between the support unit 17 and the standby position PH in the Y-axis direction. In this case, the control unit 28 moves the carriage 26 to the standby position PH.

Accordingly, even when the carriage 26 is present in the printing operation area RP, since the control unit 28 moves the carriage 26 to the standby position PH according to the positional relationship with the support unit 17, it is possible to prevent the nozzles of the head 27 from drying.

It is assumed that the abnormality detected based on the output from the first state output unit is an abnormality concerning attraction of the medium 99 on the standby position PH side with respect to the position of the carriage 26 in the Y-axis direction. In this case, the control unit 28 restricts the carriage 26 from being moved to the standby position PH. It is assumed that the abnormality detected based on the output from the first state output unit is an abnormality concerning attraction of the medium 99 on the side opposite to the standby position PH with respect to the position of the carriage 26 in the Y-axis direction. In this case, the control unit 28 moves the carriage 26 to the standby position PH.

Accordingly, since the control unit 28 determines, according to a positional relationship between the carriage 26 and the occurrence part of the attraction abnormality of the medium 99, whether to move the carriage 26 to the standby position PH, it is possible to prevent the head 27 from coming into contact with the medium 99 and prevent the nozzles from drying.

In the case of having detected an abnormality based on output from the first state output unit when the carriage 26 is present in the printing operation area RP, the control unit 28 requests the user to check the abnormality. The control unit 28 moves the carriage 26 to the standby position PH when being instructed by the user.

Accordingly, since the carriage 26 is moved to the standby position PH according to an instruction of the user even when an abnormality concerning the attraction unit 41 has been detected, it is possible to appropriately prevent the nozzles of the head 27 from drying.

The control method for the printing device 11 is a control method for the printing device 11 including the attraction unit 41 that attracts the medium 99 to the support unit 17. The control method for the printing device 11 is a control method for the printing device 11 including the head 27 that ejects the ink onto the medium 99 and the carriage 26 that is mounted with the head 27 and moves in the Y-axis direction with respect to the support unit 17. The control method for the printing device 11 is a control method for the printing device 11 including the first state output unit that outputs a state of the attraction unit 41 and the second state output unit that outputs a state of a part different from the attraction unit 41. The control method for the printing device 11 is a control method for the printing device 11 that executes the print processing involving the movement of the head 27 by the carriage 26 and the ejection of the ink by the head 27 onto the medium 99 supported by the support unit 17. The area where the carriage 26 moves when the print processing is executed is represented as the printing operation area RP and the position that is adjacent to the printing operation area RP in the Y-axis direction and where the carriage 26 stays on standby when the print processing is not executed is represented as the standby position PH. At this time, the control method for the printing device 11 includes, in the case of having detected an abnormality based on output from the first state output unit when the carriage 26 is present in the printing operation area RP, restricting the carriage 26 from being moved to the standby position PH. The control method for the printing device 11 includes, in the case of having detected an abnormality based on output from the second state output unit and having not detected an abnormality based on output from the first state output unit when the carriage 26 is present in the printing operation area RP, moving the carriage 26 to the standby position PH.

Accordingly, when the carriage 26 is moved from the printing operation area RP to the standby position PH, it is possible to prevent the head 27 from coming into contact with the medium 99 floating from the support unit 17 because of an abnormality of the attraction unit 41. Since the carriage 26 is moved to the standby position PH when an abnormality concerning the attraction unit 41 has not been detected, it is possible to prevent the nozzles of the head 27 from drying.

The printing device 11 according to the embodiment of the present disclosure basically has the configuration explained above. However, it is also naturally possible to make modifications, omissions, and the like of a part of the configuration without departing from the gist of the present disclosure.

The control method for the printing device 11 according to the embodiment of the present disclosure basically has the configuration explained above. However, it is also naturally possible to make modifications, omissions, and the like of a part of the configuration without departing from the gist of the present disclosure.

The embodiment and other embodiments explained below can be implemented in combination with each other as long as no technical inconsistencies are involved. The other embodiments are explained below.

In the embodiment explained above, the attraction unit 41 may not include the plurality of negative pressure generation mechanisms 42u, 42c, and 42d. For example, the attraction unit 41 may include one negative pressure generation mechanism 42c. In this case, the attraction unit 41 does not include the negative pressure generation mechanisms 42u and 42d. In this case, the negative pressure chamber 43c of the negative pressure generation mechanism 42c communicates with all the through holes 19 opened in the support surface 18. In this case, the control unit 28 may not execute step S140 of the flowchart illustrated in FIG. 4. That is, when determining NO in step S130 of the flowchart illustrated in FIG. 4, the control unit 28 shifts the processing to step S150.

In the embodiment explained above, when determining YES in step S140 of the flowchart illustrated in FIG. 4, the control unit 28 may not cause the carriage 26 to stay in place. For example, it is assumed that the control unit 28 determines YES in step S140 and the carriage 26 is located at a position vertically above the drying area of the drying unit 32 in the printing operation area RP. In this case, the control unit 28 may move the carriage 26 to a position in the +Y direction of the position vertically above the drying area of the drying unit 32 in the printing operation area RP. Accordingly, it is possible to prevent the nozzles of the head 27 from drying because of the atmosphere heated by the drying unit 32.

In the embodiment explained above, the attraction unit 41 may not attract the medium 99 to the support unit 17 by causing negative pressure to act on the medium 99. For example, the attraction unit 41 may attract the medium 99 to the support unit 17 by generating static electricity.

In the embodiment explained above, the printing device 11 may be a serial printer in which the carriage 26 moves only in the X-axis direction. In this embodiment, it is assumed that an abnormality has been detected based on output from the first state output unit when the carriage 26 is present in the printing operation area RP. In this case, the control unit 28 determines whether the carriage 26 is located between the support unit 17 and the standby position PH in the X-axis direction. When the carriage 26 is located between the support unit 17 and the standby position PH in the X-axis direction, the control unit 28 moves the carriage 26 to the standby position PH. Accordingly, it is possible to prevent the nozzles of the head 27 from drying. On the other hand, when the carriage 26 is not located between the support unit 17 and the standby position PH in the X-axis direction, the control unit 28 restricts the carriage 26 from being moved to the standby position PH. Accordingly, it is possible to prevent the head 27 from coming into contact with the medium 99.

Further, in this embodiment, it is assumed that the abnormality detected based on the output from the first state output unit is an abnormality concerning attraction of the medium 99 on the side opposite to the standby position PH with respect to the position of the carriage 26 in the X-axis direction. In this case, the control unit 28 moves the carriage 26 to the standby position PH. Accordingly, it is possible to prevent the nozzles of the head 27 from drying. In this case, it is preferable that the negative pressure generation mechanism 42 includes the suction unit 44 and the pressure sensor S4 that are disposed side by side in the X-axis direction and are separate.

What is claimed is:

1. A printing device comprising:
an attraction unit configured to attract a medium to a support unit;
a head configured to eject liquid onto the medium;
a carriage mounted with the head and configured to move in a main scanning direction with respect to the support unit;
a control unit;
a first state output unit configured to output a state of the attraction unit to the control unit; and
a second state output unit configured to output a state of a part different from the attraction unit to the control unit, wherein
the control unit controls the head and the carriage to execute print processing involving movement of the head by the carriage and the ejection of the liquid by the head onto the medium supported by the support unit, and
when an area where the carriage moves when the print processing is executed is represented as a printing operation area and a position that is adjacent to the printing operation area in the main scanning direction and where the carriage stays on standby when the print processing is not executed is represented as a standby position,
in a case of having detected an abnormality based on output from the first state output unit when the carriage is present in the printing operation area, the control unit restricts the carriage from being moved to the standby position, and
in a case of having detected an abnormality based on output from the second state output unit and having not detected an abnormality based on output from the first state output unit when the carriage is present in the printing operation area, the control unit moves the carriage to the standby position.

2. The printing device according to claim 1, wherein
the head includes a nozzle surface in which nozzles configured to eject the liquid are provided, and
the printing device further comprises a cap configured to cover the nozzle surface when the carriage is present at the standby position.

3. The printing device according to claim 1, wherein
the attraction unit includes:
a negative pressure generation mechanism configured to generate negative pressure; and
a pressure sensor configured to detect the negative pressure generated by the negative pressure generation mechanism, and
the pressure sensor functions as the first state output unit.

4. The printing device according to claim 1, wherein
the attraction unit includes:
a negative pressure generation mechanism configured to generate negative pressure; and
a negative pressure control unit configured to drive the negative pressure generation mechanism, and
the negative pressure control unit functions as the first state output unit.

5. The printing device according to claim 1, further comprising:
a tension applying mechanism configured to apply tension to the medium; and
a tension detection unit configured to detect the tension applied to the medium by the tension applying mechanism, wherein
the tension detection unit functions as the second state output unit.

6. The printing device according to claim 1, further comprising:
a drying unit configured to dry the medium on which the print processing was executed; and
a temperature control unit configured to detect the temperature of the drying unit, wherein
the temperature control unit functions as the second state output unit.

7. The printing device according to claim 1, wherein, in a case of having detected an abnormality based on output from the first state output unit when the carriage is present in the printing operation area and in a case in which the carriage is located between the support unit and the standby position in the main scanning direction, the control unit moves the carriage to the standby position.

8. The printing device according to claim 1, wherein
when the abnormality detected based on the output from the first state output unit is an abnormality concerning attraction of the medium on the standby position side with respect to a position of the carriage in the main scanning direction, the control unit restricts the carriage from being moved to the standby position, and
when the abnormality detected based on the output from the first state output unit is an abnormality concerning attraction of the medium on a side opposite to the standby position with respect to the position of the carriage in the main scanning direction, the control unit moves the carriage to the standby position.

9. The printing device according to claim 1, wherein, in a case of having detected an abnormality based on output from the first state output unit when the carriage is present in the printing operation area, the control unit requests a user to check the abnormality and, when being instructed by the user, moves the carriage to the standby position.

10. A control method for a printing device including: an attraction unit configured to attract a medium to a support unit; a head configured to eject liquid onto the medium; a carriage mounted with the head and configured to move in a main scanning direction with respect to the support unit; a first state output unit configured to output a state of the attraction unit; and a second state output unit configured to output a state of a part different from the attraction unit, the printing device executing print processing involving movement of the head by the carriage and the ejection of the liquid by the head onto the medium supported by the support unit,
the control method comprising:
when an area where the carriage moves when the print processing is executed is represented as a printing operation area and a position that is adjacent to the printing operation area in the main scanning direction and where the carriage stays on standby when the print processing is not executed is represented as a standby position,
in a case of having detected an abnormality based on output from the first state output unit when the carriage is present in the printing operation area, restricting the carriage from being moved to the standby position; and
in a case of having detected an abnormality based on output from the second state output unit and having not detected an abnormality based on output from the first state output unit when the carriage is present in the printing operation area, moving the carriage to the standby position.
